(19) United States
(12) Patent Application Publication
(10) Pub. No.: US 2026/0051908 A1
(43) Pub. Date: Feb. 19, 2026

(54) WIRELESS COMMUNICATION DEVICE AND RADIO FREQUENCY SIGNAL PROCESSING METHOD THEREOF

(71) Applicant: Realtek Semiconductor Corporation, Hsinchu (TW)

(72) Inventors: Wei-Chi LAI, Hsinchu (TW); Chi-Jen CHEN, Hsinchu (TW); Wei-Hsuan CHANG, Hsinchu (TW)

(21) Appl. No.: 19/284,725

(22) Filed: Jul. 30, 2025

(30) Foreign Application Priority Data
Aug. 15, 2024 (TW) 113130768

(51) Int. Cl. H04B 1/00

(52) U.S. Cl. CPC H04B 1/0096; H04B 1/0028

(57) ABSTRACT

A wireless communication device includes a mixer, a low-pass filter (LPF), an in-band analog-to-digital converter (ADC), a wideband ADC, and a baseband processor. The mixer is configured to mix a radio frequency signal and a carrier signal for performing frequency conversion on the radio frequency signal to obtain a mixed signal. The LPF is coupled to the mixer and configured to perform filtering on the mixed signal to filter out signal components of the mixed signal out of a passband to obtain a baseband signal. The in-band ADC is configured to convert the baseband signal into an in-band signal. The wideband ADC is configured to convert the mixed signal into a wideband signal. The baseband processor is coupled to the in-band ADC and the wideband ADC, and configured to compare the wideband signal with the in-band signal to determine whether an out-of-band interference exists.

### RELATED APPLICATIONS

This application claims priority to Taiwan Application Serial Number 113130768, filed Aug. 15, 2024, which is herein incorporated by reference.

### BACKGROUND

### Technical Field

The present disclosure relates to wireless communications, and more particularly to a wireless communication device and radio frequency signal processing method thereof capable of identifying interference types.

### Description of Related Art

To wireless local area network (WLAN), the Wi-Fi channel is free for users to use, so different wireless communication systems easily use the same frequency range at the same time. Without being able to detect each other, interference within the same frequency band or between adjacent frequency bands is inevitable, which has a significant impact on the stability and throughput of transmission. If the wireless communication device can implement corresponding process for different types of interference, the packet receiving performance of the system can be further improved.

### SUMMARY

One aspect of the present disclosure directs to a wireless communication device, including: a mixer, a low-pass filter (LPF), an in-band analog-to-digital converter (ADC), a wideband ADC, and a baseband processor. The mixer is configured to mix a radio frequency signal and a carrier signal for performing frequency conversion on the radio frequency signal to obtain a mixed signal. The LPF is coupled to the mixer and having a passband, and configured to perform filtering on the mixed signal to filter out signal components of the mixed signal out of the passband to obtain a baseband signal. The in-band ADC is coupled to the LPF and configured to convert the baseband signal into an in-band signal. The wideband ADC is coupled to the mixer and configured to convert the mixed signal into a wideband signal. The baseband processor is coupled to the in-band ADC and the wideband ADC, and configured to compare the wideband signal with the in-band signal to determine whether an out-of-band interference exists.

Another aspect of the present disclosure directs to a radio frequency signal processing method adapted to a wireless communication device, the radio frequency signal processing method including: mixing a radio frequency signal and a carrier signal for performing frequency conversion on the radio frequency signal to obtain a mixed signal; performing filtering on the mixed signal with a passband to filter out signal components of the mixed signal out of the passband to obtain a baseband signal; performing an in-band analog-to-digital conversion to convert the baseband signal into an in-band signal; performing a wideband analog-to-digital conversion to convert the mixed signal into a wideband signal; and comparing the wideband signal with the in-band signal to determine whether an out-of-band interference exists.

### BRIEF DESCRIPTION OF THE DRAWINGS

The foregoing aspects and many of the accompanying advantages of this disclosure will become more readily appreciated as the same becomes better understood by reference to the following detailed description, when taken in conjunction with the accompanying drawings.

FIG. 1 is a schematic diagram of a wireless communication system in accordance with some embodiments of the present disclosure.

FIG. 2 is a schematic diagram of 2.4 GHz frequency range in the IEEE 802.11 standard.

FIG. 3 is a schematic block diagram of a wireless communication device in accordance with some embodiments of the present disclosure.

FIG. 4 is a schematic diagram of the IEEE 802.11a packet format.

FIG. 5 is a flowchart of a radio frequency signal processing method in accordance with some embodiments of the present disclosure.

### DETAILED DESCRIPTION

The detailed explanation of the present disclosure is described as following. The described preferred embodiments are presented for purposes of illustrations and description, and they are not intended to limit the scope of the present disclosure.

It is understood that although the terms “first,” “second”, etc., may be used in the present disclosure to describe various signals, information and/or values, these terms are not used to limit these signals, information and/or values. These terms are only used to distinguish one signal, information and/or value from another signal, information, and/or value.

According to the current Wi-Fi system specifications, the transmission modes adopted in the Wi-Fi system may include orthogonal frequency division multiplexing (OFDM) transmission modes, High Throughput (HT) modes, Very High Throughput (VHT) modes, High Efficiency (HE) modes, and Extremely High Throughput (EHT) modes. The HT modes, the VHT modes, the HE modes, and the EHT modes correspond to wireless local area networks (WLANs) of various communication generations such as Wi-Fi 4, Wi-Fi 5, Wi-Fi 6, and Wi-Fi 7, respectively. More transmission modes are usable for a wireless communication device if the hardware specification thereof is better and the Wi-Fi system supported thereby is more advanced. The embodiments of the present disclosure also support other wired and/or wireless communication technologies such as cellular network, Bluetooth, local area network (LAN) and/or Universal Serial Bus (USB).

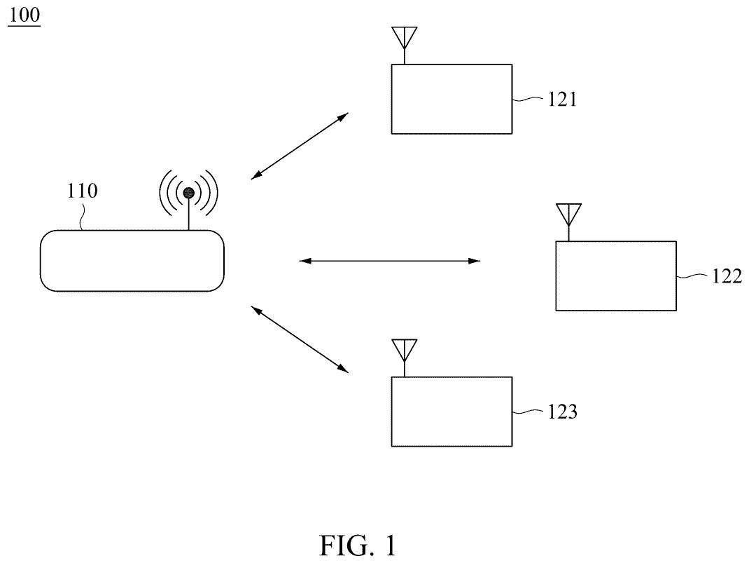

FIG. 1 is a schematic diagram of a wireless communication system 100 in accordance with some embodiments of the present disclosure. The wireless communication system 100 includes a wireless access point device 110 and wireless station devices 121-123. The wireless access point device 110 provides the wireless access service within a certain range, and each of the wireless station devices 121-123 may establish wireless communication connections with the wireless access point device 110 to access the local area network and/or wide area network (for example, Internet) via Wi-Fi channels (e.g., IEEE 802.11 channel). The wireless communication connection between the wireless access point device 110 and any of the wireless station devices 121-123 may include, but not limited to, registration procedures, identity and access management procedures, establishment and release of wireless connections, transmission and/or reception of control signals, and/or transmission and/or reception of data signal. Each of the wireless station devices 121-123 may be, for example, a smart phone, a tablet, a laptop, or other devices with wireless signal transmission and reception function. Additionally, the wireless access point device 110 may be, for example, a wireless router, a wireless switch, or a device with access point function. In other embodiments, the wireless station devices 121-123 may also have wireless access point function. It should be understood that the number of the wireless station devices is not limited to that shown in FIG. 1.

The wireless communication system 100 may support the orthogonal frequency division multiple access technology. In the wireless communication system 100, the wireless access point device 110 may divide the wireless channel resource with specific bandwidth into multiple resource units, and allocate the corresponding resource units to the wireless station devices 121-123 so that the frequency bands used by the wireless station devices 121-123 for transmitting and receiving signals at the same time do not overlap with each other. Furthermore, the wireless communication system 100 may support multiple-input multiple-output (MIMO) technology, multiple-input single-output (MISO) technology, single-input multiple-output (SIMO) technology, and/or single-input single-output (SISO) technology. Take MIMO technology as an example, the beamforming procedure is performed by the wireless access point device 110 with the wireless station devices 121-123, including: transmitting a detection frame to the wireless station devices 121-123 by the wireless access point device 110, performing a channel estimation and feeding back a channel information to the wireless access point device 110 by the wireless station devices 121-123; and establishing a beamforming steering matrices corresponding to the wireless station devices 121-123 respectively by the wireless access point device 110 for signal transmission and reception with the wireless station devices 121-123.

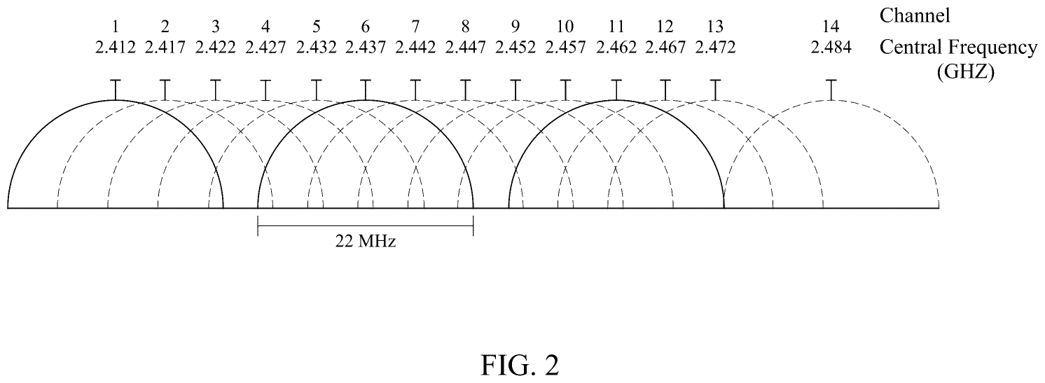

Regarding the frequency range that the wireless communication system 100 may use, the IEEE 802.11 standard specifies several frequency ranges used by wireless local area networks, such as 2.4 GHz, 4.9 GHz, and 5.8 GHz. Taking 2.4 GHz as an example, the IEEE 802.11a/b/g/n/ax standards are specified at multiple channels in the 2.4 GHz frequency range for providing for multiple users in the same wireless area network to use. FIG. 2 is a schematic diagram of 2.4 GHz frequency range in the IEEE 802.11 standard. As shown in FIG. 2, there are 14 channels in the 2.4 GHz frequency range, and the bandwidth of each channel is 2.2 MHz. The central frequency of Channel 1 is 2.412 GHz and the central frequencies of Channel 1 to Channel 13 are spaced 5 MHz apart sequentially (that is, the central frequency of Channel 2 is 2.417 GHz, and the central frequency of Channel 3 is 2.422 GHz, and so on), and the central frequencies of Channel 14 and Channel 13 are 12 MHz apart.

However, in the same frequency range for use, packets on overlapped channels cannot be correctly demodulated, resulting in a great increasing of the probability of interference with each other. For example, if a first transmitting device is transmitting on Channel 1 and a second transmitting device on Channel 2 is not transmitting packets, the first transmitting device may transmit packets to the receiving end at the OFDM 54M rate. At this time, the packet error rate (PER) counted by the first transmitting device may be below 10%, which meets the requirements of the IEEE 802.11 standard. However, if the first transmitting device and the second transmitting device transmit packets at the same time, the packet data on Channel 2 cannot be demodulated by the first transmitting device so that the first transmitting device might incorrectly determine the channel state as idle and transmit packets. At this time, the packet transmitted by the first transmitting device may not be correctly received by the receiving end, resulting in a significant increase in the PER, affecting the packet transmission quality of the entire system.

On the other hand, interference in the wireless local area network can be classified into an in-band interference and an out-of-band interference, in which the in-band interference is interference located within the frequency band used by the transmitting end for transmitting packets (for example, interference within the same channels), and the out-of-band interference is interference located out of the frequency band used by the transmitting end for transmitting packets (for example, interference between different channels). Since the processing methods for the in-band interference and the out-of-band interference are different, when the interference exists, the type of interference (the in-band interference or the out-of-band interference) is first determined and then to perform corresponding process. If the wireless communication device receiving the packets can quickly detect the type of interference and perform corresponding process in real time (adjusting reception-related parameters such as the reception rate), the overall transmission performance of the wireless communication system can be further improved.

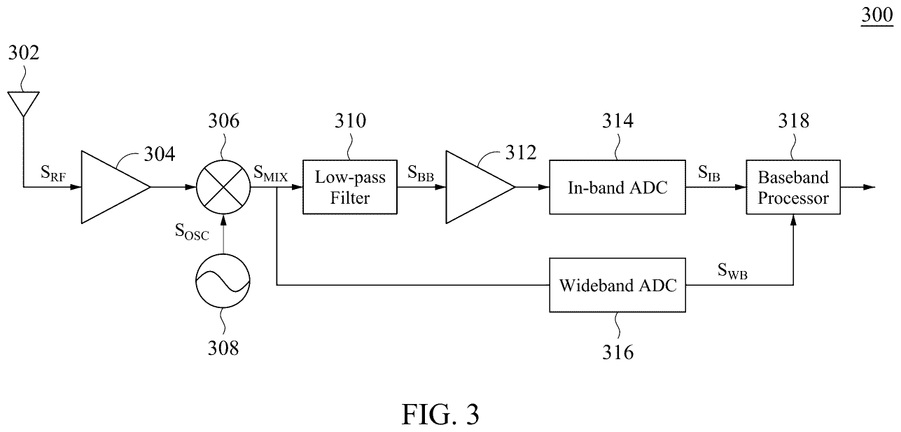

FIG. 3 is a schematic block diagram of a wireless communication device 300 in accordance with some embodiments of the present disclosure. The wireless communication device 300 may be the wireless access point device 110, the wireless station devices 121-123, or other electronic devices capable of receiving wireless signals and support standards of wireless local area networks for one or various communication generations. The wireless communication device 300 includes antenna 302, a low-noise amplifier (LNA) 304, a mixer 306, a local oscillator 308, a low-pass filter (LPF) 310, a variable gain amplifier (VGA) 312, an in-band analog-to-digital converter (ADC) 314, a wideband ADC 316, and a baseband processor 318.

The antenna 302 is used for receiving the radio frequency signal S_{RF}, and the LNA 304 is coupled to the antenna 302 to enhance the signal-to-noise ratio of the radio frequency signal S_{RF}. The mixer 306 is coupled to the LNA 304 and the local oscillator 308, and is used for mixing the radio frequency signal S_{RF} with the carrier signal S_{OSC} generated by the local oscillator 308, so as to perform frequency conversion on the radio frequency signal S_{RF} to generate a mixed signal S_{MIX}. The LPF 310 is coupled to the mixer 306 and has a passband, and is used for filtering the mixed signal S_{MIX} to filter out signal components of the mixed signal S_{MIX} out of the passband to obtain a baseband signal S_{BB}. The VGA 312 is coupled to the LPF 310, and is used for cooperating with the LNA 304 to provide a corresponding gain to the baseband signal S_{BB}.

The in-band ADC 314 is coupled to the VGA 312 and is used to convert the baseband signal S_{BB} in analog form into an in-band signal S_{IB} in digital form. In other embodiments, the wireless communication device 300 may not include the VGA 312, and the in-band ADC 314 is coupled to the LPF 310. The wideband ADC 316 is coupled to the mixer 306 and is configured to convert the mixed signal S_{MIX} in analog form into a wideband signal S_{WB} in digital form. The baseband processor 318 is coupled to the in-band ADC 314 and the wideband ADC 316, and is configured to decode the in-band signal S_{IB} to obtain bit data. The baseband processor 318 is further configured to compare the wideband signal S_{WB} with the in-band signal S_{IB} to determine whether the out-of-band interference exists.

Specifically, the baseband processor 318 may calculate the signal energy difference between the wideband signal S_{WB} and the in-band signal S_{IB} and compare the signal energy difference with the threshold value to determine whether the out-of-band interference exists. If the signal energy of the wideband signal S_{WB} is greater than the signal energy of the in-band signal S_{IB} plus the threshold value, the baseband processor 318 determines that the out-of-band interference exists. In contrast, if the signal energy of the wideband signal S_{WB} is not greater than the signal energy of the in-band signal S_{IB} plus the threshold value, the baseband processor 318 determines that the out-of-band interference does not exist.

The wireless communication device 300 may perform a corresponding process according to the comparison result by the baseband processor 318. When determining that the out-of-band interference exists, the baseband processor 318 may adjust the automatic gain control (AGC) parameters (for example, the gain of the LNA 304 and/or the VGA 312) of the wireless communication device 300 to optimize the transmission performance of the system. For example, when the out-of-band interference exists, the baseband processor 318 may decrease the gain of the LNA 304 to prevent the LNA 304 from entering the oversaturation region (non-linear region), and correspondingly increase the gain of the VGA 312 simultaneously to achieve the desired overall gain. In some embodiments, when it is known that the interference exists, if the signal energy of the wideband signal S_{WB} is not greater than the signal energy of the in-band signal S_{IB} plus the threshold value, the baseband processor 318 determines that the in-band interference exists. When determining that the in-band interference exists, the baseband processor 318 may adjust the contention window parameter of the wireless communication device 300 and/or enable a protocol protection mechanism. For example, the protocol protection mechanism may be a request-to-send/clear-to-send (RTS/CTS) protection mechanism or a CTS-to-self protection mechanism, but is not limited thereto.

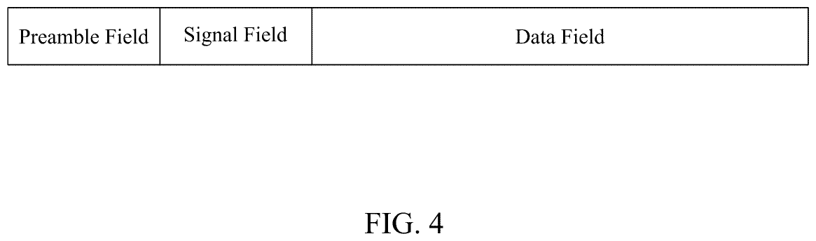

The wireless communication device 300 may use a partial segment of the received packet to determine whether the out-of-band interference exists. FIG. 4 schematically shows the packet format of IEEE 802.11a, which includes a preamble field, a signal field, and a data field. The preamble field includes a training sequence for receiver frequency calibration and channel estimation, the signal field includes information such as data length and data rate, and the data field includes multiple OFDM symbols for transmitting user data. In the present disclosure, the wireless communication device 300, with the preamble field of the received packet (corresponding to the radio frequency signal S_{RF}), may demodulate the preamble field (including the frequency conversion on the radio frequency signal S_{RF}, filtering on the mixed signal S_{MIX}, conversion of the baseband signal S_{BB} in analog form into the in-band signal S_{IB} in digital form, and conversion of the mixed signal S_{MIX} in analog form into the digital wideband signal S_{WB} in digital form mentioned above), and then detect and compare the signal energy of the wideband signal S_{WB} and the in-band signal S_{IB} to determine whether the out-of-band interference exists, and transmit the determination result to the baseband processor 318, so that the baseband processor 318 adjusts the demodulation mechanism correspondingly to enhance the demodulation capability on the signal field and the data field of the packet, thereby improving the packet receiving performance of the system.

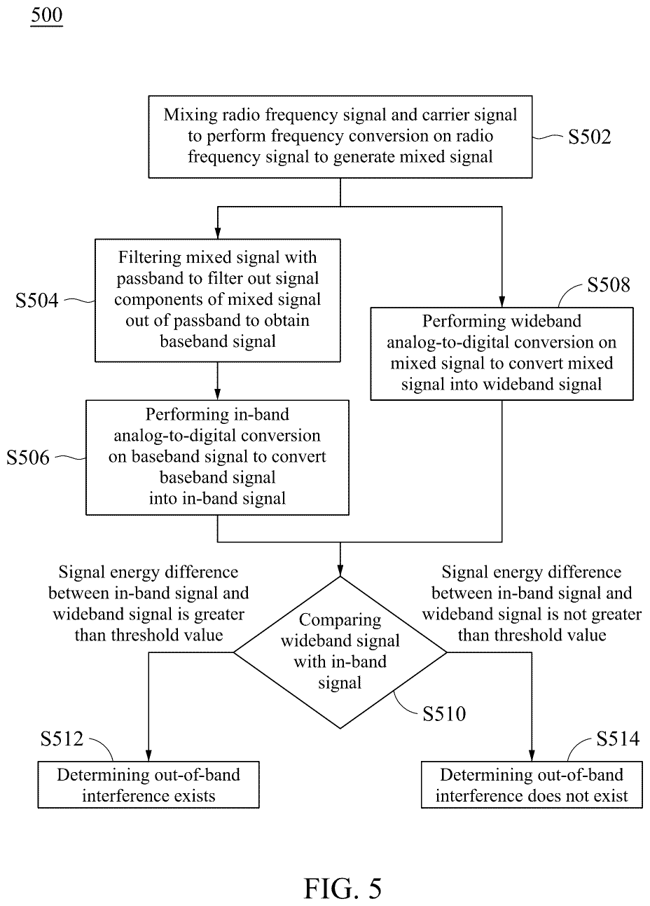

FIG. 5 is a flowchart of a radio frequency signal processing method in accordance with some embodiments of the present disclosure. The radio frequency signal processing method 500 is applicable to the wireless communication device 300 in FIG. 3 or other wireless communication devices with similar functions, and is described as follows. First, operation S502 is performed to mix the radio frequency signal and the carrier signal to perform frequency conversion on the radio frequency signal to generate the mixed signal. In some embodiments, the radio frequency signal corresponds to the preamble field of the packet received by the wireless communication device. Next, operation S504 is performed to filter the mixed signal with the passband to filter out the signal components of the mixed signal out of the passband to obtain the baseband signal, and then operation S506 is performed to perform the in-band analog-to-digital conversion on the baseband signal to convert the baseband signal into the in-band signal. After operation S502 is completed, operation S508 is performed simultaneously to perform a wideband analog-to-digital conversion on the mixed signal to convert the mixed signal into the wideband signal. After operations S506 and S508 are completed, operation S510 is then performed to compare the wideband signal with the in-band signal to determine whether the out-of-band interference exists. Specifically, operation S510 is to determine whether the signal energy difference between the in-band signal and the wideband signal is greater than the threshold value. If the signal energy difference between the in-band signal and the wideband signal is greater than the threshold value (that is, the signal energy of the wideband signal is greater than the signal energy of the in-band signal plus the threshold value), operation S512 is performed to determine that the out-of-band interference exists. In contrast, if the signal energy difference between the in-band signal and the wideband signal is not greater than the threshold value (that is, the signal energy of the wideband signal is not greater than the signal energy of the in-band signal plus the threshold value), operation S514 is performed to determine that the out-of-band interference does not exist. When determining that the out-of-band interference exists, the AGC parameters of the wireless communication device may be adjusted, for example, the gain of the radio frequency signal may be decreased, and the gain of the baseband signal may be correspondingly increased.

In some embodiments, under the premise of known interference, if the signal energy difference between the in-band signal and the wideband signal is not greater than the threshold value (that is, the signal energy of the wideband signal is not greater than the signal energy of the in-band signal plus the threshold value), it is determined that the in-band interference exists. When determining that the in-band interference exists, the wireless communication device may adjust the contention window parameter and/or enable the protocol protection mechanism. For example, the protocol protection mechanism is to enable the RTS/CTS protection mechanism or a CTS-to-self protection mechanism, but is not limited thereto.

It will be apparent to those skilled in the art that various modifications and variations can be made to the structure of the disclosure without departing from the scope or spirit of the disclosure cover modifications and variations of this disclosure provided they fall within the scope of the following claims.

What is claimed is:

1. A wireless communication device, comprising:
a mixer configured to mix a radio frequency signal and a carrier signal for performing frequency conversion on the radio frequency signal to obtain a mixed signal;
a low-pass filter (LPF) coupled to the mixer and having a passband, the LPF configured to perform filtering on the mixed signal to filter out signal components of the mixed signal out of the passband to obtain a baseband signal;
an in-band analog-to-digital converter (ADC) coupled to the LPF and configured to convert the baseband signal into an in-band signal;
a wideband ADC coupled to the mixer and configured to convert the mixed signal into a wideband signal; and
a baseband processor coupled to the in-band ADC and the wideband ADC and configured to compare the wideband signal with the in-band signal to determine whether an out-of-band interference exists.

2. The wireless communication device of claim 1, wherein the baseband processor is configured to calculate a signal energy difference between the wideband signal and the in-band signal and compare the signal energy difference with a threshold value to determine whether the out-of-band interference exists.

3. The wireless communication device of claim 2, wherein if the signal energy difference is greater than the threshold value, the baseband processor determines that the out-of-band interference exists.

4. The wireless communication device of claim 3, wherein when determining that the out-of-band interference exists, the baseband processor adjusts an automatic gain control (AGC) parameter of the wireless communication device.

5. The wireless communication device of claim 2, wherein if the signal energy difference is not greater than the threshold value, the baseband processor determines that an in-band interference exists.

6. The wireless communication device of claim 5, wherein when determining that the in-band interference exists, the baseband processor adjusts a contention window parameter.

7. The wireless communication device of claim 5, wherein when determining that the in-band interference exists, the baseband processor enables a protocol protection mechanism.

8. The wireless communication device of claim 7, wherein the protocol protection mechanism is a request-to-send/clear-to-send (RTS/CTS) protection mechanism or a CTS-to-self protection mechanism.

9. The wireless communication device of claim 1, wherein the radio frequency signal corresponds to a preamble field of a packet received by the wireless communication device.

10. The wireless communication device of claim 1, further comprising:
a low-noise amplifier (LNA) coupled to the mixer and configured to amplify a signal-to-noise ratio of the radio frequency signal; and
a variable gain amplifier (VGA) coupled to the LPF and the in-band ADC and configured to cooperate with the LNA to provide a corresponding gain to the baseband signal.

11. A radio frequency signal processing method adapted to a wireless communication device, the radio frequency signal processing method comprising:
mixing a radio frequency signal and a carrier signal for performing frequency conversion on the radio frequency signal to obtain a mixed signal;
performing filtering on the mixed signal with a passband to filter out signal components of the mixed signal out of the passband to obtain a baseband signal;
performing an in-band analog-to-digital conversion to convert the baseband signal into an in-band signal;
performing a wideband analog-to-digital conversion to convert the mixed signal into a wideband signal; and
comparing the wideband signal with the in-band signal to determine whether an out-of-band interference exists.

12. The radio frequency signal processing method of claim 11, wherein comparing the wideband signal with the in-band signal is to calculate a signal energy difference between the wideband signal and the in-band signal and compare the signal energy difference with a threshold value.

13. The radio frequency signal processing method of claim 12, further comprising:
when the signal energy difference is greater than the threshold value, determining that the out-of-band interference exists.

14. The radio frequency signal processing method of claim 13, further comprising:
when determining that the out-of-band interference exists, adjusting an AGC parameter of the wireless communication device.

15. The radio frequency signal processing method of claim 14, wherein adjusting the AGC parameter of the wireless communication device comprises decreasing a first gain of the radio frequency signal and correspondingly increasing a second gain of the baseband signal.

16. The radio frequency signal processing method of claim 12, further comprising:
when the signal energy difference is not greater than the threshold value, determining that an in-band interference exists.

17. The radio frequency signal processing method of claim 16, further comprising:
when determining that the in-band interference exists, adjusting a contention window parameter of the wireless communication device.

18. The radio frequency signal processing method of claim 16, further comprising:
when determining that the in-band interference exists, enabling a protocol protection mechanism.

19. The radio frequency signal processing method of claim 18, wherein the protocol protection mechanism is an RTS/CTS protection mechanism or a CTS-to-self protection mechanism.

20. The radio frequency signal processing method of claim 11, wherein the radio frequency signal corresponds to a preamble field of a packet received by the wireless communication device.
